(19) United States
(12) Patent Application Publication
(10) Pub. No.: US 2013/0191264 A1
(43) Pub. Date: Jul. 25, 2013

(54) SYSTEM AND METHOD FOR COLLATERAL CONVERSION

(71) Applicant: The Bank Of New York Mellon, A New York Banking Corporation, New York, NY (US)

(72) Inventor: Mark I. ROBINSON, New York, NY (US)

(73) Assignee: THE BANK OF NEW YORK MELLON, A NEW YORK BANKING CORPORATION, New York, NY (US)

(21) Appl. No.: 13/724,893

(22) Filed: Dec. 21, 2012

Related U.S. Application Data
(60) Provisional application No. 61/580,066, filed on Dec. 23, 2011.

(51) Int. Cl. G06Q 40/04

(52) U.S. Cl. CPC G06Q 40/04
USPC 705/37

(57) ABSTRACT

A computer-implemented method and system for converting ineligible collateral including a plurality of differently securitized asset types into non-trust collateral eligible for use to cover a margin requirement for securities trading includes a processor and a memory coupled to the processor and a database configured to at least store financial information relating to the ineligible collateral, A network connection is operatively coupled to the processor, and the processor is configured to receive the financial information over the network and store the financial information in the database; create a plurality of universal collateral units (UCU) backed by the pool of ineligible collateral. Each of the created UCUs represents the non-trust collateral eligible for use to cover the margin requirement. At least a portion of the UCUs are issued as a letter of credit in an electronic form, and the letter of credit is made available to a clearinghouse or a central counterparty via the network connection.

This application claims the benefit of U.S. Provisional Application Ser. No. 61/580,066, filed Dec. 23, 2011, the content of which is incorporated in its entirety herein by reference.

### BACKGROUND

This application is directed to a computer-implemented system and method useful for allowing currently unutilized and/or underutilized collateral to be used to meet collateral requirements related to the trading of various derivative financial instruments. In particular, this application is directed to a computerized system and method for converting currently unutilized and/or underutilized collateral for use in a financial transaction, e.g., for use as margin for over-the-counter (OTC) derivatives and exchange traded futures transactions, or other financial transactions.

In global capital markets, access to collateral is critical. With increased risk aversion, increasingly complex credit requirements prevalent in the financial markets, and increased governmental regulation, finding available collateral for a collateralized transaction can be a challenging task, particularly in providing trading parties the ability to derive maximum utility from their financial holdings. The ability to assess what securities can be used as collateral, and with whom, is vital to the efficiency of using collateral. In addition, current regulatory requirements require migration from bilateral marketplaces to a cleared marketplace, which has created a need for more collateral. Current projections indicate that there is not enough collateral to meet projected needs for margin requirements for over-the-counter (OTC) derivatives and exchange traded futures, for example. Further, some collateral is considered to be ineligible for some purposes by certain parties, e.g., residential mortgage backed securities (RMBS), commercial mortgage backed securities (CMBS), agency MBS (e.g., Freddie Mac and Fannie Mae), AA-rated corporate bonds, and equities are generally not considered to be acceptable or eligible for use as collateral. These instruments represent a currently untapped source of potential collateral.

One conventional approach attempts to alleviate this problem in the (re)insurance industry by creating eligible collateral from fixed income securities that qualify for New York State Regulation 114, and U.S. equities that qualify as admitted assets for New York domiciled insurance companies, along with European fixed income securities denominated in U.S. dollars, Euros, and/or British Pound Sterling rated A− or better, and equities traded on a major European exchange (e.g., in Germany, United Kingdom, and France). The form of collateral issued is a financial guarantee in the form of fully secured demand notes, which have been designed to enable the ceding insurance company to take credit for reinsurance solvency relief under U.S. insurance laws and U.K. insurance regulations. The resulting collateral is a perpetual demand note that is in a master trust and which carries the obligation to pay the face amount upon call, and which functions as a practical. A demand note is generally secure and fully funded, and can be drawn upon as necessary. In this conventional approach, however, the collateral functions as an alternative to Letters of Credit (LOC) and individually funded trusts, and is fully backed by a portfolio of high quality assets, i.e., a specialized demand note, that can be used to support general credit enhancement, U.S. reserve credit requirements for reinsurance for intra-company and third party agreements, and for various regulatory reserves. In this approach, there are concerns about structural shortcomings of letters of credit because risk-based capital guidelines have led to tightening of terms for traditional LOC.

Alternative sources of collateral exist include client balance sheets, commercial bank LOC, and capital markets which establish unique securitizations structured and distributed by banks and investment banks. In addition, unsecured and fully secured LOCs are theoretically available, but unsecured LOCs are subject to price volatility and capacity due to credit market cycles, bank capital adequacy trends, and (re)insurance market cycles. In addition, fully secured LOCs are generally becoming more costly due to the requirement to pledge higher quality/lower yielding securities and maintain higher levels of over-collaterization, and higher pricing.

What is needed is a system and method for converting and/or expanding currently ineligible collateral into a form that is available for use in a financial transaction. What is also needed is a computer-implemented system and method that converts currently ineligible collateral into collateral that is eligible for use as margin in an OTC derivative and/or exchange traded futures trading, and which reduces the risk to involved parties associated with the collateralization of the trade. What is further needed is a computer-implemented system and method that provides eligible collateral for use as margin in an OTC derivative and/or exchange traded futures trading, and which is subject to minimal or no regulatory oversight.

### SUMMARY

Through various embodiments described herein, the system and method of this disclosure reduces the risk and complexity associated with collateralized financial transactions. For example, various embodiments provide functions related to converting currently ineligible collateral into collateral eligible for a particular trade. Various aspects provide the ability to avoid costly governmental regulation.

In an embodiment, a data processing system for converting ineligible collateral comprising a plurality of differently securitized asset types into non-trust collateral eligible for use to cover a margin requirement for securities trading includes a processor and a memory coupled to the processor and a database configured to at least store financial information relating to the ineligible collateral. A network connection is operatively coupled to the processor, and the processor is configured to receive the financial information over the network and store the financial information in the database; create a plurality of universal collateral units (UCU) backed by the pool of ineligible collateral. Each of the created UCUs represents the collateral eligible for use to cover the margin requirement. At least a portion of the UCUs are issued as a letter of credit in an electronic form, and the letter of credit is made available to a clearinghouse or a central counterparty via the network connection.

In an embodiment, a computer-implemented method for converting ineligible collateral comprising a plurality of differently securitized asset types into non-trust collateral eligible for use to cover a margin requirement for securities trading includes providing a data processing system comprising a memory coupled to a processor and containing a database therein configured to at least store financial information relating to the ineligible collateral; providing a network connection operatively coupled to the processor; receiving the financial information over the network and storing the financial information in the database; creating a plurality of universal collateral units (UCU) backed by the pool of ineligible collateral, wherein each of the created UCUs represents the non-trust collateral eligible for use to cover the margin requirement; issuing at least a portion of the UCUs as a letter of credit in an electronic form; and making the letter of credit available to a clearinghouse or a central counterparty via the network connection.

In an embodiment, an article of manufacture comprising a tangible computer-readable storage medium that contains computer-executable code thereon which, when executed by a processor, causes the processor to carry out functions that convert ineligible collateral comprising a plurality of differently securitized asset types into non-trust collateral eligible for use to cover a margin requirement for securities trading, wherein the executed code is operable to: store financial information relating to the ineligible collateral in a memory containing a database therein; allow communications over a network connection operatively coupled to the processor; receive the financial information over the network and store the financial information in the database; create a plurality of universal collateral units (UCU) backed by the pool of ineligible collateral, wherein each of the created UCUs represents the collateral eligible for use to cover the margin requirement; issue at least a portion of the UCUs as a letter of credit in an electronic form; and make the letter of credit available to a clearinghouse or a central counterparty via the network connection.

In one aspect of an embodiment, the letter of credit is a standby letter of credit. In another aspect of an embodiment, a third party operations provider may be accessed via the network connection. In a further aspect, the letter of credit is made available to a central counterparty, e.g., the Options Clearing Corporation (OCC). In another aspect of an embodiment, the ineligible collateral comprises two or more asset classes selected from the group including residential mortgage backed securities, commercial mortgage backed securities, agency mortgage backed securities, equities, and AA-rated corporate bonds.

In an aspect of an embodiment, two or more of the plurality of differently securitized asset types may be combined to form a pool of ineligible collateral which is subsequently rendered eligible.

In an aspect of an embodiment, the system may also include a user interface, and may include a web portal for operating over the Internet.

The system and method of this disclosure provides various capabilities as discussed more fully in the detailed description below.

### BRIEF DISCUSSION OF THE DRAWINGS

FIG. 1 provides a functional block diagram of an embodiment of a computer-implemented and networked system for collateral conversion and management;

FIG. 2 provides a logic flowchart that implements a collateral conversion algorithm and other rules relating to collateral conversion in an embodiment of this disclosure;

FIG. 3 depicts an embodiment of an organization of an entity that could sponsor and/or control a central collateral utility such as the collateral conversion system;

FIG. 4 depicts an embodiment of an organization of a central collateral utility such as the collateral conversion system, utilizing how universal collateral units may be used; and

FIG. 5 depicts another embodiment of an organization of a central collateral utility, such as the collateral conversion system.

### DETAILED DESCRIPTION

In the discussion of various embodiments and aspects of the system and method of this disclosure, examples of a processor may include any one or more of for instance, a personal computer, portable computer, personal digital assistant (PDA), workstation, or other processor-driven device, and examples of network may include, for example, a private network, the Internet, or other known network types, including both wired and wireless networks.

This disclosure can be implemented via electronic circuitry, or in computer hardware, firmware, software, or in combinations of hardware and software, including a computer program product, i.e., an article of manufacture, that contains a physical/tangible computer-readable storage medium with computer program instructions tangibly embodied therein, for execution by, or to control the operation of, data processing apparatus, e.g., a programmable processor, a computer, or multiple computers. Methods of this disclosure can be performed by one or more programmable processors executing a computer program to perform functions described herein by operating on input data and generating output. Such methods can also be performed by, and the system of this disclosure can be implemented as special purpose circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

In the discussion of various embodiments and aspects of the system and method of this disclosure, examples of trading parties include, but are not limited to, broker-dealers, institutional investors, and hedge fund managers.

In various embodiments, a web-based collateral management system or platform links dealers with investors to convert collateral in a safe, efficient, and reliable way. Online dealers and investors can manage collateral among a diverse range of instruments, including tri-party repo agreements in all major currencies, securities lending transactions, municipal deposits, bank loans, derivatives transactions, letters of credit, and structured trades, for example,

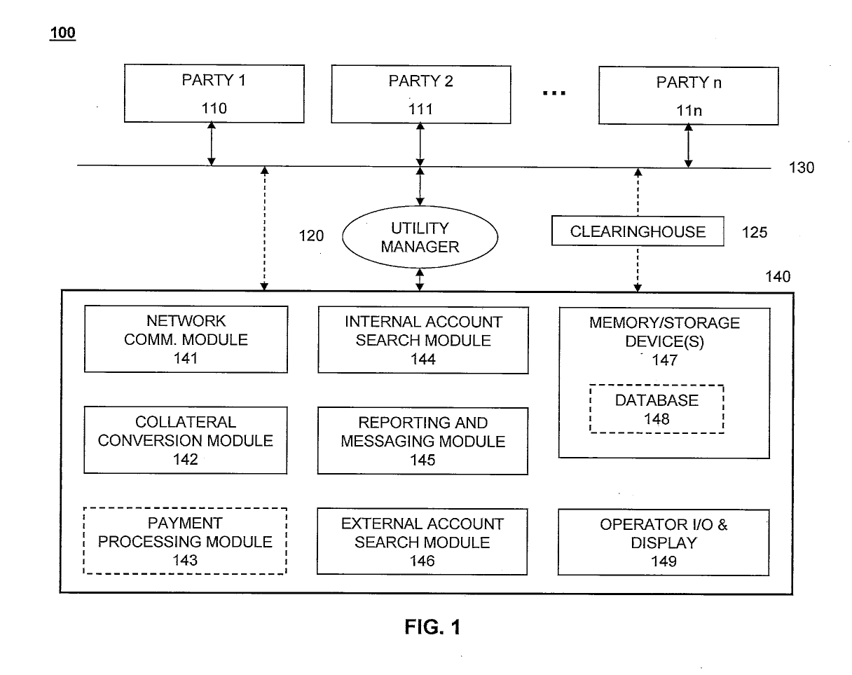

Turning now to the drawing figures, the embodiment of FIG. 1 illustrates a functional block diagram of collateral conversion arrangement 100 in which parties 110, 111, . . . , 11n access collateral conversion system 140 via network 130 and utility manager 120, or optionally bypasses utility manager 120. Collateral conversion system 140 may include network communication module 141 configured to process external communications between collateral conversion system 140 and network 130. Collateral conversion module 142, described below, is configured using one or more processors (not shown) to evaluate various security positions in terms of their potential suitability as collateral for a particular financial trade or transaction, including the application of any “haircut” on the collateral based on the liquidity risk of the particular type of collateral. Payment processing module 143, indicated in dashed lines, represents optional functionality associated with business payment activities for services rendered by the utility manager in processing and converting collateral for a financial trade. Internal account search module 144 may be configured to search one or more databases associated with client assets collateralized for, or for the benefit of various existing clients of platform manager 120. Internal account search module 144 may be configured to search for a particular type of security or asset, a particular security issuer, or a security rating, for example. Similarly, external account search module 146 may be configured to search various parameters associated with accounts that are not held in custody or for the benefit of existing clients of platform manager 120. Reporting and messaging module 145 may be configured to provide standard and/or custom report and messaging formats that may be transferred to network 130 by collateral conversion system 140, (optionally) through utility manager 120, or through an alternate communications path illustrated by the dashed double-ended arrow in FIG. 1. Memory storage device(s) 147, may include one or more databases 148 therein. Memory storage device 147 may be any type of conventional storage mechanism for example, random access memory (RAM), and database 148 may be any type of appropriate database, as would be known by a person of ordinary skill in the art, for example. Operator input/output and display module 149 represents various techniques and computer peripheral devices for providing operator input and output to collateral conversion system 140.

The system and method of this disclosure may be implemented in various ways, including a graphical-user-interface (GUI) as represented, at least in part, by operator I/O and display module 149 in FIG. 1.

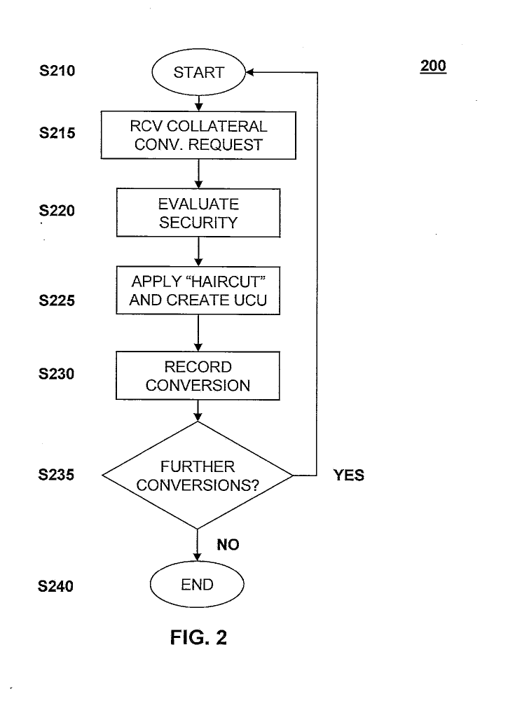

FIG. 2 provides a flow chart of an exemplary process using the collateral conversion system of FIG. 1, which starts at step S210, and proceeds to step S215 where a collateral conversion request is received. At step S220, the security is evaluated for its relative risk liquidity. For example, different securities are more or less liquid than other securities, and are considered to be ineligible for collateral purposes since clearinghouses are not allowed to use securities with higher liquidity risk than, for example, AAA-rated corporate bonds. Such ineligible collateral includes, e.g., residential mortgage backed securities (RMBS), commercial mortgage backed securities (CMBS), agency MBS (e.g., Freddie Mac and Fannie Mae), AA-rated corporate bonds, and equities.

Based upon the type of ineligible collateral being offered, an applicable “haircut” is applied at step S225. In finance, a haircut is a percentage that is subtracted from the market value of an asset that is being used as collateral. The size of the haircut reflects the perceived risk associated with holding the asset. However, the lender has a lien for the entirety of the asset. For example, United States Treasury bills, which are seen as fairly safe, might have a haircut of 1%, while for stock options, which are seen as highly risky, the haircut might be as high as 30%. In other words, a $1000 treasury bill will be accepted as collateral for a $990 loan, while a $1000 stock option might only allow a $700 loan. Other rates may apply to RMBS and CMBS securities, among others, for example. Lower haircuts allow for more leverage.

Further in step 225, after the haircut is applied, a universal collateral unit (UCU) is created, representing collateral that is now eligible for use in derivatives markets, for example. At step S230, the collateral is recorded in, for example, memory storage device(s) 147. This collateral is now eligible for use in derivative and/or futures trading. Due to the unique structure of the creating entity, the created UCUs will all have the same AAA rating, thus making them eligible as collateral.

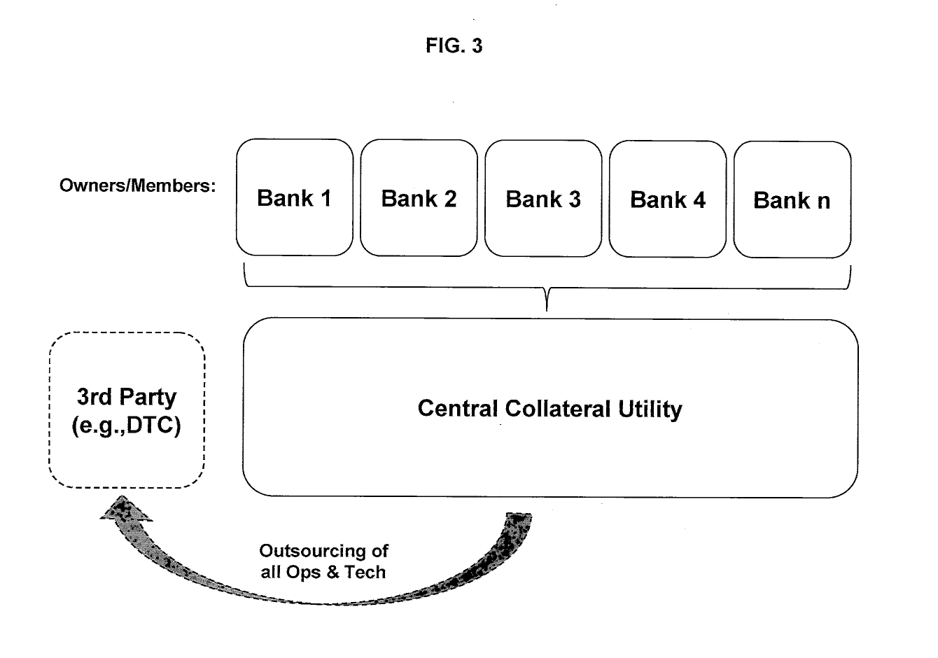

FIG. 3 depicts the organization of an entity that could sponsor and/or control a central collateral utility (CCU) such as collateral conversion system 140. Several legal and/or financial considerations go into creation of this entity. For example, the CCU cannot be a bank or it would be regulated under stringent Basel III reserve and reporting requirements for banks. A bank entity that attempted to convert securities with liquidity risk more than AAA-rated corporate bonds would fail the Basel III liquidity ratio test. One approach is to require a consortium of five or more banks and third party outsourcing of various technical aspects and operations to avoid certain banking regulations. One example of a third party is the Depository Trust Corporation (DTC). The entity may be organized as a limited liability company (LLC) which should be significantly capitalized, e.g., $500 million. In the case of a loss during liquidation, owners/members would be subject to a call up to an amount equal to their guarantee fund contribution. Operations and management would be overseen by a Board of Directors that should include both broad representation of owners and directors independent of the member banks and other investors.

Such an LLC would be organized to include customary “bankruptcy remoteness” provisions. Although no entity is bankruptcy “proof”, users will want robust bankruptcy/receivership remote structure that may adopt the following common features: a supermajority board vote to file voluntary petition or to liquidate, consolidate, merge, etc., and must include approval of independent director(s); non-petition agreements from key creditors/vendors/suppliers including the banks and other “sponsoring”” investors; the LLC's activities may be limited to providing collateral instruments, all other activities may be limited by charter; strict limits/prohibitions on incurrence of debt or liabilities unrelated to core business; separate audited financial statements; insulate from third party liabilities and assets including separate books and records, observe organizational formalities, pay own employees and expenses, fairly allocate shared overhead, hold itself out as entity separate from the banks and other investors; and robust capital maintenance.

The credit support obligation, e.g., the UCU of the issuing entity is preferably a non-trust instrument, and may be unsecured senior debt obligation structured as a LOC, e.g., a standby LOC. A LOC may be most familiar and commercially acceptable instrument in the market. In addition, a LOC is generally seen as least subject to payment delays, defenses, setoffs, etc., and such LOC obligations may mitigate entity risk of regulation as financial guarantee insurer, Although usually issued by banks, a non-bank issuer may lawfully issue a LOC.

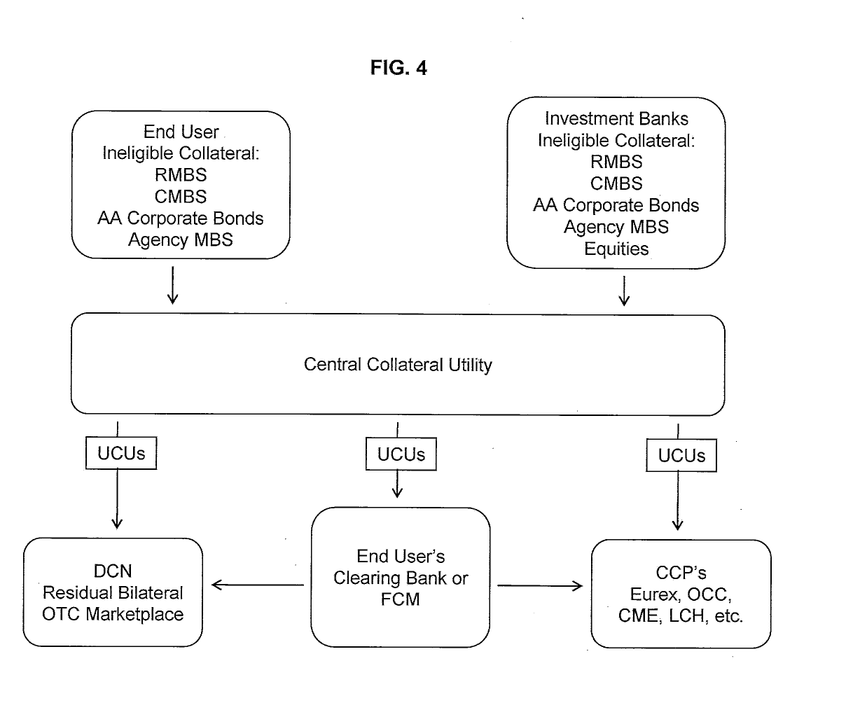

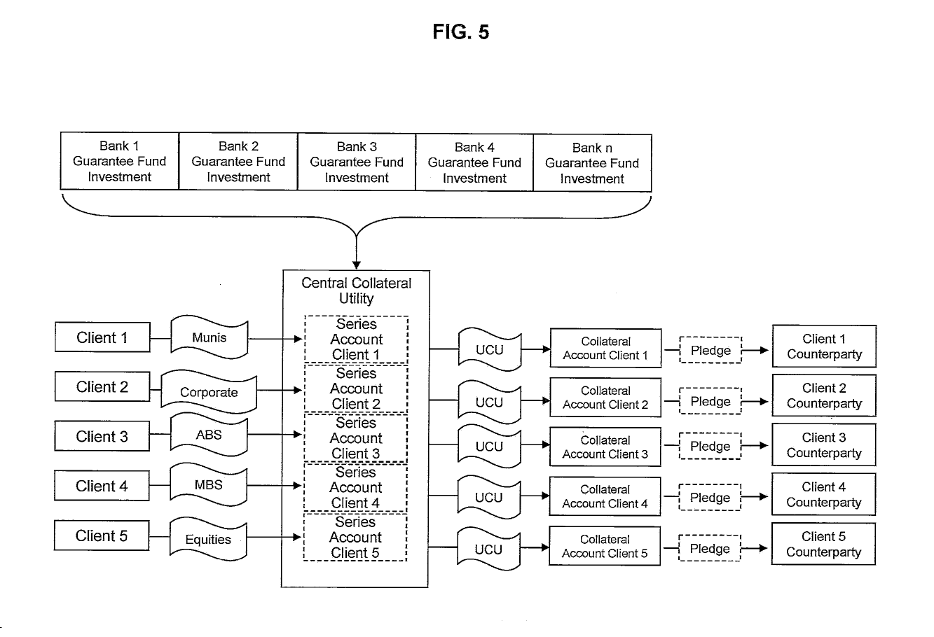

FIG. 4 provides another view of the organization of a CCU such as collateral conversion system 140, and how the UCUs may be used. FIG. 5 provides yet another depiction of how the CCU, such as collateral conversion system 140, is organized (i.e., owners are Banks 1-n) that provide guarantee fund investments to the CCU entity. FIG. 5 illustrates five clients 1-5, each of which provides a different type of ineligible collateral to the CCU. The CCU may create accounts for each client, and issue or “convert” a number of UCUs commensurate with the offered securities. A collateral account for each client may be established in memory 147 and/or database 148. Such collateral-eligible UCUs may be pledged to an associated counterparty for clearing of a trade.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A data processing system for converting ineligible collateral comprising a plurality of differently securitized asset types into non-trust collateral eligible for use to cover or pledge a margin requirement for securities trading, the system comprising:
a processor and a memory coupled to the processor and containing a database therein configured to at least store financial information relating to the ineligible collateral; and
a network connection operatively coupled to the processor, wherein the processor is configured to:
receive the financial information over the network and store the financial information in the database;
create a plurality of universal collateral units (UCU) backed by the ineligible collateral, wherein each of the created UCUs represents the non-trust collateral eligible for use to cover the margin requirement,
wherein at least a portion of the UCUs are issued as a letter of credit in an electronic form, and wherein the letter of credit is made available to a clearinghouse or a central counterparty via the network connection.

2. The system of claim 1, wherein the letter of credit is a standby letter of credit.

3. The system of claim 1, further comprising a third party operations provider accessible via the network connection.

4. The system of claim 1, wherein the letter of credit is made available to a central counterparty, wherein the central counterparty is the Options Clearing Corporation (OCC).

5. The system of claim 1, wherein the ineligible collateral comprises two or more asset classes selected from the group including residential mortgage backed securities, commercial mortgage backed securities, agency mortgage backed securities, equities, and AA-rated corporate bonds.

6. The system of claim 1, wherein the processor is further configured to combine two or more of the plurality of differently securitized asset types to form a pool of the ineligible collateral.

7. A computer-implemented method for converting ineligible collateral comprising a plurality of differently securitized asset types into non-trust collateral eligible for use to cover a margin requirement for securities trading, the method comprising:
receiving financial information over a network connection operatively coupled to a processor and memory containing a database therein configured to at least store financial information relating to the ineligible collateral, and storing the financial information in the database;
creating a plurality of universal collateral units (UCU) backed by the ineligible collateral, wherein each of the created UCUs represents the non-trust collateral eligible for use to cover the margin requirement;
issuing at least a portion of the UCUs as a letter of credit in an electronic form; and
making the letter of credit available to a clearinghouse or a central counterparty via the network connection.

8. The method of claim 7, wherein the letter of credit is a standby letter of credit.

9. The method of claim 7, further comprising providing access to a third party operations provider via the network connection.

10. The method of claim 7, further comprising making the letter of credit available to a central counterparty, wherein the central counterparty is the Options Clearing Corporation (OCC).

11. The method of claim 7, wherein the ineligible collateral comprises two or more asset classes selected from the group including residential mortgage backed securities, commercial mortgage backed securities, agency mortgage backed securities, equities, and AA-rated corporate bonds.

12. The method of claim 7, further comprising combining two or more of the plurality of differently securitized asset types to form a pool of the ineligible collateral.

13. An article of manufacture comprising a tangible computer-readable storage medium that contains computer-executable code thereon which, when executed by a processor, causes the processor to carry out functions that convert ineligible collateral comprising a plurality of differently securitized asset types into collateral eligible for use to cover a margin requirement for securities trading, wherein the executed code is operable to:
store financial information relating to the ineligible collateral in a memory containing a database therein;
allow communications over a network connection operatively coupled to the processor;
receive the financial information over the network and store the financial information in the database;
create a plurality of universal collateral units (UCU) backed by the pool of ineligible collateral, wherein each of the created UCUs represents the collateral eligible for use to cover the margin requirement;
issue at least a portion of the UCUs as a letter of credit in an electronic form; and
make the letter of credit available to a clearinghouse or a central counterparty via the network connection.
